(19) United States
(12) Patent Application Publication
(10) Pub. No.: US 2009/0176487 A1
(43) Pub. Date: Jul. 9, 2009

(54) Wireless Repeater Management Systems

(76) Inventor: Anthony DeMarco, Newport Beach, CA (US)

Correspondence Address: FISH & ASSOCIATES, PC;ROBERT D. FISH, 2603 Main Street, Suite 1000, Irvine, CA, 92614-6232, US

(21) Appl. No.: 12/328,076

(22) Filed: Dec. 4, 2008

Related U.S. Application Data
(60) Provisional application No. 61/018,765, filed on Jan. 3, 2008.
(60) Provisional application No. 61/018,892, filed on Jan. 4, 2008.
(60) Provisional application No. 61/019,097, filed on Jan. 4, 2008.

(51) Int. Cl. H04W 88/04; H04B 7/14

(52) U.S. Cl. 455/422.1; 455/7

(57) ABSTRACT

Management systems wireless repeaters are presented. Contemplated systems can include a local management device that brokers a management lock between the repeater and a controller, which can be either local or remote. Once a management lock is in place, the repeater restricts execution of management commands to those issued by the controller to resolve potentially conflicting commands issued from multiple authorized controllers. In some embodiments, the controller and lock brokering device are the same device.

This application claims the benefit of priority to U.S. Provisional Application having Ser. No. 61/018,765 filed on Jan. 3, 2008, and to U.S. Provisional Applications having Ser. Nos. 61/018,892 and 61/019,097 both filed on Jan. 4, 2008. These and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is management technologies for wireless devices.

### BACKGROUND

Wireless repeaters are used to relay wireless signals from a wireless device to a remote base station, or other remote wireless devices. When repeaters are installed, they must be configured for proper operation in their environment. For example, the repeater must be configured to support proper carriers (e.g., GSM, CDMA, etc.), to provide management data, or to otherwise operate correctly. Repeaters can be managed by a local technician or, as is more often the case, by a remote Operations Support System (OSS).

Wireless repeaters are becoming smaller and more personalized, which can cause many management issues. One management issue arises when multiple authorized entities attempt to issue conflicting management commands to the repeater. If two or more authorized individuals, possibly an owner of the repeater and a technician, wish to manage the repeater at the same time, their respective management commands could be in conflict and should be restricted to ensure conflicts are resolved. This issue is further exacerbated when an authorized entity includes a remote OSS that is unaware of the management activities occurring locally to the wireless repeater. Ideally, multiple managers of wireless repeaters should be able to issue management commands to a repeater without conflict, preferably through some for of restriction.

Others have put forth effort toward wireless repeater management. For example, in U.S. patent application publication 2002/0028655 to Rosener et al. titled “Repeater System”, users are able to selectively enable a repeater's core modules that affect the operation of the repeater. However, the commands issued to the repeater are not restricted from executing when conflicting commands are issued.

International patent application WO 2006/099209 to McKay titled “Remotely Controllable and Reconfigurable Wireless Repeater” makes further progress by offer a solution where a wireless repeater can be controller or configured locally or remotely. McKay also lacks any provisions for handling conflicting management commands.

International patent application WO 2001/82512 to Park titled “System and Method for Supervising Repeater by Using Wireless Mobile” provides for some level of management of wireless repeaters by having monitoring apparatus installed with the repeater. Park also fails to provide for ensuring that management commands do not conflict.

U.S. Pat. No. 6,718,160 to Schmutz titled “Automatic Configuration of Backhauled Groundlink Frequencies in a Wireless Repeater” contemplates that a wireless repeater can be configured via a remote wireless link. Just as in the previous examples of repeater management, Schmutz also lacks for locking down management commands to reduce the risk of conflicting management commands.

What has yet to be appreciated is that wireless repeater management commands can be locked in a manner that restricts the execution of the command. Management locks can be brokered by a local wireless device (e.g., a cell phone) which can act as an intermediary between the repeater and a local or a remote controller. Once a lock is established for a management command, conflicting commands can be restricted from execution.

Thus, there is still a need for wireless repeater management systems.

### SUMMARY OF THE INVENTION

The inventive subject matter provides apparatus, systems and methods in which wireless repeaters can be locally (e.g., within 100 meters) or remotely managed. A handheld wireless management device preferably communicates with a local repeater and with a controller that is configured to control or otherwise manage the repeater. In a preferred embodiment, the management device brokers a management lock between the repeater and the controller where the lock can restrict the execution of control commands to those issued by the controller. Once a proper management lock is established for a control command, the command can be executed by the repeater. Contemplated control commands can include those pertaining to monitoring the repeater, sending alerts, configuring alarms, inventorying the repeater, logging events, reporting, applying security measures, activating/deactivating capabilities (e.g., power, channels, cloning phone attributes, etc.), or other management related commands.

In some embodiments, the handheld device is local to the repeater (e.g., within 100 meters) and communicates with the repeater via a wireless communication link. Wireless communications links can include Bluetooth, wireless USB, 802.11, IrDA, CDMA, GSM, or other wireless protocols. Although the handheld device can operate as a controller that issues management commands to the repeater, it is also contemplated that the controller can be remote to the repeater, possibly in a remote central office more than 10 Km from the repeater. In such embodiments, the handheld device can act as a proxy or otherwise relay commands to the repeater, preferably in near real-time (e.g., in less than 1 second).

Another aspect of the inventive subject matter includes a system for managing a wireless device. A device controller configured to issue one or more management commands to the wireless device can communicate with the wireless device preferably via a wireless link. A lock brokering device can operate as a intermediary between the wireless device and the controller to broker management locks relating to the management commands. When a management lock is in place, the wireless device can allow the execution of the management commands.

Various objects, features, aspects and advantages of the inventive subject matter will become more apparent from the following detailed description of preferred embodiments, along with the accompanying drawings in which like numerals represent like components.

### BRIEF DESCRIPTION OF THE DRAWING

FIG. 1 is a schematic of a possible wireless repeater environment where a wireless repeater is managed by a controller once a handheld device brokers a management lock.

### DETAILED DESCRIPTION

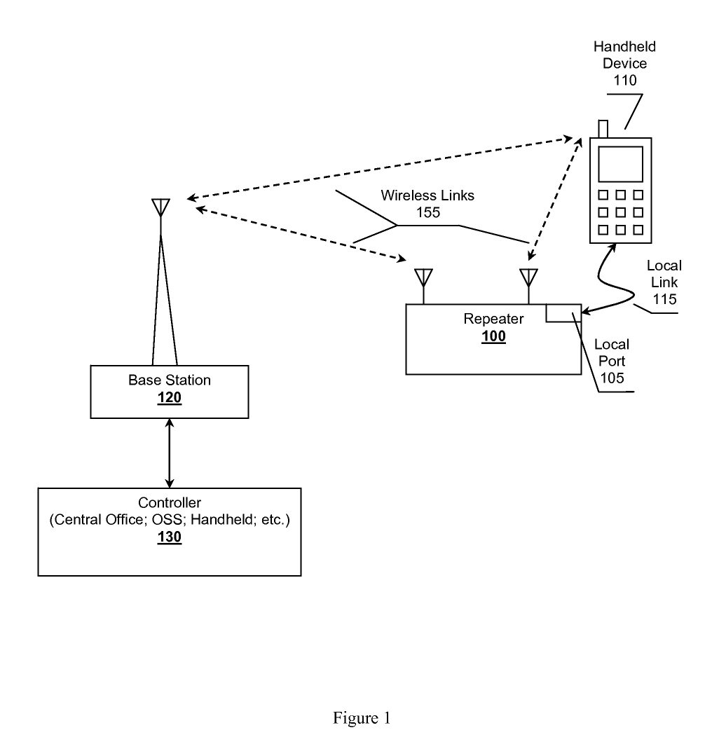

In FIG. 1, repeater 100 can be managed by controller 130. In a preferred embodiment, handheld wireless device 110 functions as a management lock broker between repeater 100 and controller 130.

Repeater 100 represents wireless repeater that preferably boosts signals from a first wireless device, possibly handheld device 110, to a remote device, possibly base station 120. In a preferred embodiment, repeater 100 comprises a personal repeater configured to boost signals from a mobile telephony device. Acceptable repeaters comprise two or more antenna (e.g., a coverage antenna and a donor antenna) for exchanging wireless signals via wireless links 155. Example personal wireless repeaters include those developed and sold by Cellynx™, Inc. of Mission Viejo, Calif. (http://www.cellynx.com/). For example, repeater 100 could include a 5BarZ™ SOHO unit or a 5BarZ™ Universal unit. Additional details regarding acceptable repeaters can be found in co-owned pending U.S. patent applications having Ser. No. 11/625,331 titled “Cell Phone Signal Booster” and having Ser. No. 12/106,468 titled “Dual Cancellation Loop Wireless Repeater”.

In embodiments where repeater 100 comprises a personal repeater, repeater 100 can also operate as a home base station where the home base station provides similar functionality as a cordless phone cradle. Rather than interfacing to the Plain Old Telephone System (POTS), the base station interfaces to a wireless cell phone network and eliminates the need for a POTS line. Cell phones within the coverage area of the home base station repeater can operate as a cordless phone by connecting to the base station using wireless links 155 or even local link 115. The base station repeater can clone the attributes of the cell phone to allow the base station repeater to connect to a cell phone carrier's network. In a preferred embodiment, the cloning process can include establishing one or more management locks (described below) to restrict access to the base station repeater's capability by other cell phones, if desired by a carrier or an owner of the repeater.

Repeater 100 comprises hardware including a processor and memory for storing software instructions for execution on the processor. In a preferred embodiment, the software instructions include functionality that allows repeater 100 to exchange management information with controller 130, where the management information can include one or more control commands issued to repeater 100 from controller 130. When a control command is received, the repeater 100 can execute the command by calling corresponding functions or modules within the software instructions as is well known. In some embodiments, repeater 100 has software instructions programmed to operate as an HTTP server though which repeater can be managed.

Repeater 100 preferably includes one or more local communication ports 105 to enable communications with other local devices, including handheld device 110. Port 105 can include a wired port (e.g., RS-232, USB, FireWire, Ethernet, etc.) or, more preferably, a wireless port (e.g., 802.11, 802.15, Z-Wave, BlueTooth, wireless USB, IrDA, 802.16, etc.). It is also contemplated that repeater 100 could utilize its coverage antenna as local port 105.

Controller 130 is preferably configured to issue one or more control commands to repeater 100 where control commands affect the management of repeater 100. Controller 130 can send the control commands directly to repeater 100 via base station 120 using wireless links 155. Alternatively, controller 130 can send the control commands indirectly to repeater 100 by using handheld device 110 as an intermediary node or as a proxy. Once handheld device 110 receives a control command targeting repeater 100, device 110 can forward the command to repeater 100 over local link 115. In a preferred embodiment, the control commands are restricted from execution based on a management lock brokered by handheld device 110 as discussed below.

Controller 130 and repeater 100 can exchange management information using various methods of communications. Preferably the various elements of the management system utilize communications links 155 or 115 for “store and forward” messaging protocols, or for near real-time end-to-end communications where latencies are preferably less than one second. For example, controller 130 and repeater 100 can employ Short Messaging Service (SMS) protocols, Multimedia Messaging Service (MMS), a data call, or embedded control signaling in the air interface signaling protocol.

Controller 130 can be local or remote to repeater 100. In a preferred embodiment, controller 130 is the same device as handheld device 110 and is local (e.g., within 100 meters) of repeater 100. It is also contemplated that controller 130 can be geographically separated from repeater 100 by more 5 Km, 10 Km, or even more than 100 Km. For example, controller 130 could be located as part of a computer system located in a central office for a cell phone carrier or a remote Operations Support System (OSS) of a telecommunication service provider.

Control commands are preferably management commands that affect a configuration or an operation of repeater 100, where as used herein “control command” and “management command” are used interchangeably. Contemplated management commands includes those used for monitoring, inventorying, logging events, alerting, configuring alarms, reporting, recovering, establishing security, or otherwise controlling repeater 100. Control commands can comprise a monitor command that instructs repeater 100 to collect data or metrics about its operation (e.g., up-time, number of users, etc.). Another example of a control command includes an alert or an alarm command that instructs repeater 100 to send a notification to a remote device, possibly handheld device 110 or controller 130, once a specified condition or trigger has occurred. Yet another example of a control command includes a lock or an unlock command to enable or disable, respectively, a capability of repeater 100. In especially preferred embodiments, control commands include at least one of an activate or a deactivate command. For example, an activate command could enable repeater 100 to activate its “on-air” activity. A corresponding deactivate command could deactivate the “on-air” activity of repeater 100, possibly restricting other devices from gaining accessing on-air activity. Other contemplated control commands include commands for powering repeater 100 on or off, commands for loading firmware or software, or even configuration commands.

In some embodiments repeater 100 is configured to be compatible across multiple cell phone wireless technologies (e.g., CDMA, CDMA-2000, W-CDMA, TD-SCDMA, TDMA, GSM, etc.). In such embodiments, configuration commands can be quite useful. For example, a configuration command can be sent from controller 130 to repeater 100 that instructs repeater 100 to restrict operation to a specific carrier. A configuration command can also instruct repeater 100 to restrict operation to a set of wireless devices belonging to a common wireless plan. For example, if repeater 100 is installed in a home of a family having multiple cell phones in a single cell phone plan, repeater 100 could be configured to only operate with those cell phones belonging to the family, possibly appearing on a single invoice. It is also contemplated that repeater 100 could be configured to restrict operation to a single cell phone. Such an approach enables various telecommunications providers to purchase a generic, full band repeater that can be configured for exclusive use by the carrier, the family, or the cell phone.

Consider, for example, a scenario where a telecommunications provider elects to provide a personal generic, full band repeater in the home to replace a cordless phone base station. The provider can configure the personal repeater to essentially “lock out” cell phones from other carriers by establishing a management lock on the repeater's cell phone attribute cloning capabilities. Once the management lock is established, the repeater restricts other non-provider cell phones of issuing control commands, or otherwise using the repeater. Additionally, the management lock can be used to essentially pair a repeater to single sell phone, if desired.

In a preferred embodiment control commands are grouped according to a classification scheme. Preferred classification schemes comprise a management command hierarchy where commands are arranged at different levels based on their functionality or impact on repeater 100. For example, commands associated with simply viewing data (e.g., a monitoring or a reporting command) could be considered low-level commands while commands associated with control (e.g., powering or resetting commands) could be considered high-level commands. Each level of a management command hierarchy could also correspond to permission levels or access levels available to users. If a user, controller 130, or handheld device 110 has sufficient privileges, then they can access a corresponding level of commands. One skilled in the art will recognize that the use of the terms “low” or “high” with respect to levels in a hierarchy are relative. The levels and their dependencies can be arranged as desired while still falling within the scope of the inventive subject matter. In some embodiments, as discussed below, commands are locked or otherwise restricted from execution via a management lock that applies to management commands at a common level of the management hierarchy.

In a preferred embodiment, wireless management handheld device 110 is a management lock brokering device that preferably communicates wirelessly with repeater 100 and with controller 130. Handheld device 110 preferably communicates with repeater 100 over local link 115 using any acceptable wireless communication technology (e.g., 802.11, 802.15, Z-Wave, BlueTooth, wireless USB, IrDA, 802.16, etc.). Preferred devices 110 include mobile devices or other portable wireless terminals having telephony capabilities (e.g., cell phone, PDA, iPhone, laptop, etc.). Contemplated devices 110 could be a cell phone used by a technician but owned by a telecommunication provider, or more preferably a personal cell phone owned by an individual that owns or purchases repeater 100. As previously discussed, handheld device 110 and controller 130 could be the same physical device. One should note that device 110 preferably operates within the coverage area of repeater 100. For example, in an embodiment where handheld management device 110 is a cell phone, the cell phone is preferably within range of the coverage antenna of repeater 100.

Wireless management handheld device 110 is preferably configured to broker a management lock between controller 130 and repeater 100 with respect to one or more management commands to be issued by controller 130. A management lock represents functionality of repeater 100 where repeater 100 restricts execution of one or more management commands when the lock is in place. One should note the distinction between a management lock and other forms of restrictions, especially restrictions associated with authentication or authorization. A management lock prevents a command from being executed even when an issuer of the command has been authenticated or authorized to issue the command. Authentication informs repeater 100 of the identity of an accessing entity (e.g., controller 130, device 110, a user, etc.) where authorization grants an accessing entity permission to access functionality of repeater 100.

Management locks could be considered a security primitive that can be combined with other authentication or authorization means to resolve conflicting control commands issued from different controllers 130, or even from the same controller 130. In one aspect of the inventive subject matter, once controller 130 has been suitably authenticated or authorized, a management lock can be established with repeater 100 that restricts other controllers from accessing functionality of repeater 100. In other more preferred aspects, once controller 130 has been suitably authenticated or authorized, a management lock can be established to limit access to control command functions as a function of the lock on a command-by-command basis. For example, a management lock could apply to all management commands where repeater restricts execution to only one command issued by controller 130 while all other management commands are excluded from execution. A management lock could also apply to some of the management commands. For example, once device 110 brokers a management lock for a command, the lock could apply to all other commands at a common level within a management command hierarchy. Commands at the common level, or possibly at a higher level or even a lower level, could be restricted from execution. Furthermore, a lock could apply to a single command where the same command issued from other controllers 130 are restricted from execution while other, different command are allowed to be executed.

An example will provide additional clarity. Consider a scenario where there are two authorized controllers 130: a cell phone operated by the owner of repeater 100 and a wireless terminal PDA of a service technician. The technician could attempt to reset repeater 100 to factory defaults while the owner is attempting to configure a channel assignment. The PDA could broker a management lock that restricts the owner from altering channel assignments, even if the owner or their cell phone is properly authenticated or authorized to issue such control commands.

Authentication of device 110 or controller 130 can be achieved using any suitable means. Example acceptable authentication methods can include any of the following methods, assuming proper adaptation: password exchange, key exchange, certificates, HMAC, OpenID, Kerberos, RADIUS, or other forms of authentication. Preferably, once authentication is complete, device 110 or controller 130 can be authorized to issue commands as a function of existing management locks or various identification information.

Handheld device 110 can broker a management lock via a protocol exchange between device 110 and repeater 100, or between controller 130 and repeater 100. In some embodiments, the management lock can be transmitted as a raw signal where the presence of the signal represents sufficient information for repeater 100 to establish the lock. In such embodiments, the signal preferably encodes identification information of device 100, controller 130, commands, or other data to ensure proper authorization or authentication as a management entity. In a more preferred embodiment, device 110 brokers a management lock by transmitting one or more data packet over link 115, preferably using a link agnostic protocol. During the protocol exchange, repeater 100 can communicate with controller 130 directly via wireless links 155 or via device 110 over link 115 and through links 155.

In a preferred embodiment, device 110 and repeater 100 exchange one or more data packets encoding management lock information. The lock information can include, among other data, identification of device 110 (e.g., a MAC address, GUID, etc.), identification of controller 130, control command identification, user identification, or other desirable information. Once brokering the lock is complete and repeater 100 establishes the lock, the lock information can be stored in the memory of repeater 100 using known database or data structure techniques. Repeater 100 can use the lock information to establish one or more management locks to restrict execution of management commands to the control commands issued by controller 130, possibly through device 110. When an additional command issued, repeater 100 can search its memory for management locks that pertain to the additional command. If a lock exists, information relating to the additional command (e.g., issuing controller identification, command identification, command hierarchy level, authorization data, authentication data, etc.) can be compared to the lock information to determine if the additional command should be restricted from execution.

Handheld device 110 can provide a relay for management information between repeater 100 and controller 130. As controller issues management commands, management data could be returned in response to executing the commands. The management data (e.g., reports, metrics, alerts, alarms, etc.) can be sent via link 115 to device 110. Device 110 can relay the management messages associated with the management commands from repeater 100 back to controller 130. In a preferred embodiment, device 110 relays the messages in near real-time (e.g., with a latency of less than one second). As illustrated in FIG. 1, controller 130 and device 110 can communicate over a cell phone network.

In a preferred embodiment, repeater 100 restricts execution of a management command as a function of a management lock that is in place. Repeater 100 can check lock information associated with the management lock to determine the disposition of a command issued by controller 130. Contemplated lock information, as previously discussed, can include controller identification, lock brokering device information, command information, authentication data, authorization data, or other data. The information can be compared to similar data associated with the issuing command to determine if the command should be executed or not.

If a command is found to be restricted from execution, repeater 100 can manage the disposition of the command in many different ways. In one embodiment, a restriction on one or more commands can be temporal where a management lock remains effective for a period of time. Once the life time of the management lock is exceeded, commands can be executed. In other embodiments, commands can be placed on a queue where they are stored until a lock is lifted. At which point, repeater 100 begins processing queued commands. It is also contemplated that repeater 100 could simply discard commands, possibly silently, that a restricted from execution. It is also specifically contemplated that a management lock could remain in place until specifically removed by an authorized entity. Such permanent locks allow carriers to configure generic, full-band repeaters to work only with acceptable cell phones, and prevent the repeaters from being used by other carriers.

The inventive subject matter has been presented within the scope of managing a wireless repeater. However, one should appreciate that the disclosed techniques could also be applied to the management of wireless devices in general, where repeater 100 is a wireless device. Wireless devices (e.g., cell phones, repeaters, wireless access points, etc.) can be managed via a device controller that is configured to issue management commands to the wireless device as described above in reference to controller 130. Furthermore, a lock brokering device (e.g., handheld device 110) capable of communicating with the controller or the wireless device can be configured to broker a management lock where the lock relates to commands exchanged between the controller and the wireless device.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A wireless repeater management system, comprising
a wireless repeater;
a controller in communication with the repeater and configured to issue a control command to the wireless repeater;
a handheld wireless management device in communication with the repeater and the controller, and adapted to broker a management lock with the repeater and with respect to the control command; and
wherein the repeater restricts execution of management commands to the control command issued from the controller as a function of the management lock.

2. The system of claim 1, wherein the controller and the management device are the same device.

3. The system of claim 1, wherein the management device is local to the repeater

4. The system of claim 1, wherein management device is configured to broker the management lock with the wireless repeater over a wireless communication link.

5. The system of claim 4, wherein the wireless communication link comprises a protocol selected from the group consisting of: Bluetooth, wireless USB, 802.11, and IrDA.

6. The system of claim 1, wherein the controller is remote to the wireless repeater.

7. The system of claim 6, wherein the management device is configured to relay messages associated with the control command between the controller and the repeater.

8. The system of claim 7, wherein the message are relayed in near real-time.

9. The system of claim 6, wherein the management device and the controller communicate wirelessly using a cell phone network.

10. The system of claim 1, wherein the management device comprises a cell phone.

11. The system of claim 10, wherein the management device comprises a personal cell phone.

12. The system of claim 1, wherein the control command includes at least one of the following commands activate on-air activity, and deactivate on-air activity.

13. The system of claims 1, wherein the control command comprises a monitor command.

14. The system of claim 1, wherein the control command comprises an alert command.

15. The system of claim 1, wherein the control command comprises an unlock command.

16. The system of claim 1, wherein the control command comprises a configure command.

17. The system of claim 16, wherein the configure command restricts the repeater to operate with wireless devices belonging to a common wireless plan.

18. The system of claim 16, wherein the configure command restricts the repeater to operate with a single wireless device.

19. The system of claim 1, wherein the management lock applies to a group of management commands at a common level within a management command hierarchy.

20. A system for managing a wireless device, the system comprising:
a device controller in wireless communication with a wireless device and configured to issue management commands to the wireless device;
a lock brokering device in wireless communication with the wireless device and the device controller, and configured to broker a management lock relating to the management commands between the device controller and the wireless device; and
wherein the wireless device restricts execution of the management commands to those issued from the controller as a function of the management lock.

21. The system of claim 20, wherein the wireless device comprises a wireless repeater.

22. The system of claim 21, wherein the wireless device comprises a personal cell phone repeater.

23. The system of claim 20, wherein the controller device and the lock brokering device are the same device.

24. The system of claim 20, wherein the lock brokering device comprises a cell phone.
